(19) United States
(12) Patent Application Publication
(10) Pub. No.: US 2010/0110657 A1
(43) Pub. Date: May 6, 2010

(54) Instrument Panel And Gauge With Ultraviolet Indicia

(75) Inventor: Paul Fredrick Luther Weindorf, Novi, MI (US)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/265,066

(22) Filed: Nov. 5, 2008

(51) Int. Cl. G01D 11/28

(52) U.S. Cl. 362/23

(57) ABSTRACT

An instrument panel including nanophosphor indicia which is not visible under normal lighting conditions and low light conditions, but emits visible light in response to UV light.

### BACKGROUND OF THE INVENTION

1. Field of the Invention

The present invention relates to instrument panels and gauges that are selectively lighted with ultraviolet (UV) light and in particular, instrument panels and gauges including ultraviolet indicia and markings that are not visible until UV light is applied.

2. Discussion

Vehicle manufacturers continually strive to differentiate vehicles in the marketplace by providing unique styling and aesthetic features. As part of this differentiation, many manufacturers attempt to provide a unique cockpit look and feel for the operator of the vehicle. As part of this unique look and feel, each vehicle manufacturer attempts to have a differentiate their instrument panels and gauges but have been limited by requirements of space and functionality for the various readouts, gauges, status signals, warning lights, and other required information displays. The required space for the numerous gauges, informational lights and other informational interactions, including status signals limits available design options for instrument displays and gauges.

Instrument panels and gauges are typically backlighted, which limits design options. More specifically, designers are limited by available space and by the number of gauges, informational displays and status lights to be incorporated. Examples of common gauges in automotive vehicles include speed, engine RPM, engine temperature which may include water temperature, oil temperature, oil pressure, fuel level and time. Examples of various status signals commonly used in vehicles include check engine lights, oil pressure lights, engine temperature lights, low fuel lights, turn signal lights, hazard lights, various status symbols, light or high-beam lights, fog lights, seatbelt lights, glow plug lights, and various other status lights that provide information to the operator of the vehicle when an operator does not need information as detailed as a gauge would typically provide. Therefore, it is desirable to have an instrument panel that allows for more gauges, informational displays, status signals, and warning lights within a smaller space or the same space, and to minimize the required size of the instrument panel or gauges.

To differentiate vehicles, manufactures continually strived to provide unique styles and designs and in particular to the look and feel of the gauges on the instrument panel. As the available display and lighting options have remained the same for many years, manufacturers have been limited in providing meaningful styling and functionality differences to consumers, other than shape, colors, and layout of gauges. In addition, it is difficult and expensive with backlit gauges to provide different color warning lights in close proximity while ensuring that no light leaks between adjacent lights.

Therefore, it is desirable to provide an instrument panel and gauges that allow for new styles and functionality while at the same time providing clearly readable gauges especially in low lit conditions. It is also desirable to have more information clearly communicated to the driver in the same amount of space, or even in less space.

Many operators miss when the needle on a gauge indicates an operational parameter outside of desired operating condition. For example, vehicle operators sometimes miss status signals such as temperature being too hot, low oil pressure, low fuel and more. To draw attention to the gauge indicating a reading outside of desired operational characteristics, many manufacturers including redundant dummy lights or other warning lights to draw the user's attention to the gauge. These redundant warnings add manufacturing costs and require needed space on the instrument panel. Therefore, it is desirable to clearly communicate and capture an operator's attention while eliminating redundancies that require extra space on the backplate.

Many instrument planes use lighted pointers in low light conditions. The pointers are located above the surface of the backplate and receive light through a light pipe extending cylindrically through the backplate and about the rotational axis of the pointer. The design requirements to provide light to these lighted pointers significantly limits the style of gauges and pointers that may be used. It is difficult, particularly for longer pointers, such as speedometer pointers, to brightly and uniformly light the entire pointer along its length. Also, any bends in the length of the pointer decrease the available light along the length of the pointer. To address these problems, some manufacturers actively light their pointers with an integrated diode, however, these are costly to manufacture and difficult to provide power to the diode, while allowing the pointer to operationally rotate for numerous cycles. The power mechanism to light pointers also requires valuable space behind the backplate.

### SUMMARY OF THE INVENTION AND ADVANTAGES

The present invention is directed to an instrument panel or gauges for a vehicle that include indicia such as markings, status signals, and warning signals that are invisible under normal visible lighting conditions but illuminate visibly when UV light is applied.

The gauges include a back plate having a display surface including various indicia for providing information to the operator of the vehicle. The display surface may be front illuminated or back illuminated with visible light in low light conditions and includes visible indicia under normal lighting conditions without illumination and when illuminated with visible light. The instrument panel or gauges further include nanophosphorus particles that are not visible until UV light is applied. The nanophosphor particles may be formed from dies, individual molecules or particles. The nanophosphor particles are arranged in patterns to create indicia to communicate information to the user of the vehicle.

At least one UV light source is provided within the instrument panel to front light the nanophosphorus particles. When the nanophosphorus particles are exposed to UV light from the UV light source, the indicia formed by the nanophosphorus material clearly appears and is visible to the user in both daylight and low ambient light conditions. The indicia, even though not visible when no UV light is applied, is visible in bright daylight when UV light is applied. It is important to note that without the UV light source, the nanophosphorus particles and indicia formed thereby are not visible and instead the driver sees through the substrate including the nanophosphorus particles to the display surface against which it is engaged, or applied to.

A transparent member is provided between the user and the UV light source and is configured to block UV light. The blocking of UV light ensures that direct sunlight incident on the backplate does not activate the nanophosphorus particles and protects the operator from UV light produced by the UV light source.

A pointer that is easy to manufacture and is clear, translucent, or one color under visible light, but becomes another color when UV light is applied.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Other advantages of the present invention will be readily appreciated and more fully understood by reference to the following detailed description when considered in connection with the accompanying drawing wherein:

FIG. 1 shows an exemplary instrument panel using individual and separate gauges;

FIG. 2 shows an instrument panel including an instrument cluster having gauges within the cluster;

FIG. 3 is an enlarged view of an instrument cluster with a first active UV indicia in response to a first UV wavelength of light;

FIG. 4 is an exemplary sectional view of an instrument cluster with a UV light source;

FIG. 5 is an enlarged sectional view of the backplate identified as V in FIG. 4;

FIG. 6 is the further enlarged sectional view of the backplate from V1 in FIG. 5;

FIG. 7A illustrates the instrument cluster of FIG. 3 with a second active UV indicia in response to a second UV wavelength of light under a first UV light wavelength;

FIG. 7B illustrates the instrument cluster of FIG. 3 with a third active UV indicia in response to a third UV light wavelength;

FIG. 7C illustrates the instrument cluster of FIGS. 3, 7A and 7B with an active dummy light illuminated with visible light from behind the backplate and no applied UV light; and

FIG. 8 illustrates a pointer being illuminated by nanophosphorus particles.

### DETAILED DESCRIPTION OF THE INVENTION

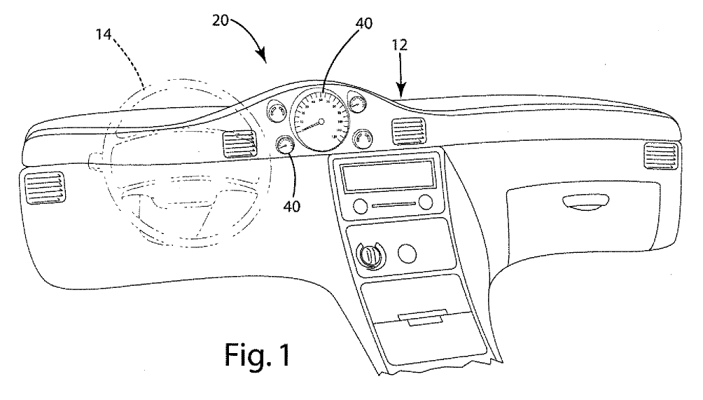

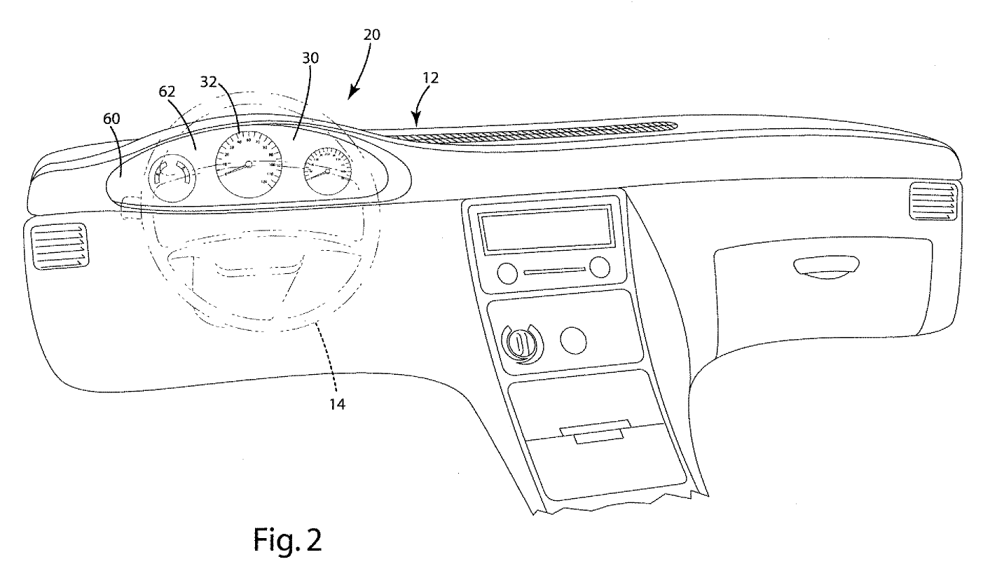

The present invention is generally directed to an instrument panel 20 having a plurality of individual gauges 40 (FIG. 1), at least one of an instrument cluster (FIG. 2), or a combination thereof (not illustrated). Of course, the instrument cluster 30 includes various gauges 32 within the cluster, such as shown on the exemplary single backplate 60. The present invention includes a UV light source and UV indicia applied to the backplate 60. The UV indicia light up or illuminate with visible light in response to UV light from the UV light source. Although the instrument panel 20 is illustrated as being located in the dashboard 12 of the vehicle 12, and particularly applicable to vehicles, the present invention is not limited to vehicles and may be used in a wide variety of settings.

The instrument panel 20 may take on any size, shape or configuration and may vary depending upon the type of the vehicle or other setting into which the instrument panel 20 is installed. Of course, the present invention does not require a complete instrument panel 20 with an instrument cluster (FIG. 2) or multiple gauges (FIG. 1), but may be used within a single gauge 40. As illustrated in FIG. 1, the instrument panel 20 may be made up of a variety of gauges 40 as well as other electronic systems. As further illustrated in FIG. 2, the instrument panel 20 may be formed as a more traditional vehicle instrument panel including an instrument cluster 30 located substantially in front of the steering wheel 14.

The instrument cluster 30 and gauges 40 are generally formed in a similar fashion having a housing 50 which secures and locates a backplate 60 and a transparent plate 70 disposed some distance from the backplate 60. A UV light source 80 is included to illuminate any UV indicia or markings 90. Backplate 60 may include on the front surface 62 various visible indicia and markings 44 which do not require light from the UV light source 80. The difference generally between an instrument cluster 30 and gauges 40 is that the instrument cluster 30 includes a plurality of instrument cluster gauges 32 on a single backplate 60, which are similar to the individually housed gauges 40 in FIG. 1. If the instrument panel 20 includes various independent gauges 40, each independent gauge 40 having a UV indicia or markings to be lighted would each need at least one UV light source 80, while the instrument cluster 30 may require only one UV light source 80 for the whole instrument cluster 30. Of course both the gauge 40 and the instrument cluster 30 may include multiple UV light sources 80. The remaining invention shall be generally described below as being applicable to both instrument clusters 30 and gauges 40.

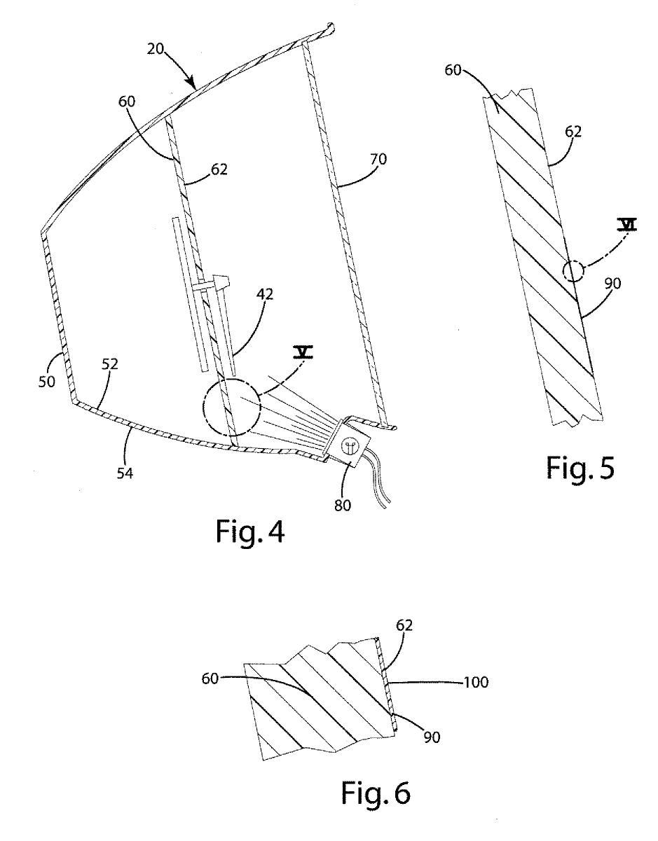

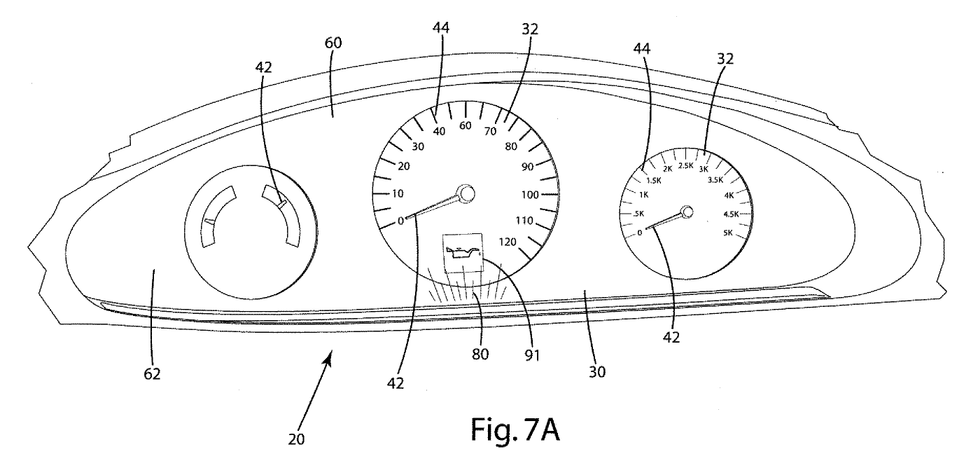

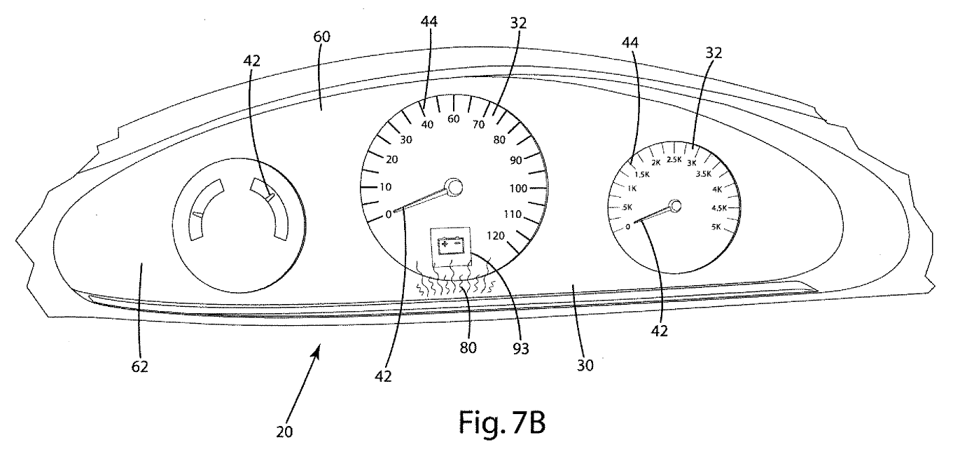

The housing 50 for the gauges 40 or instrument cluster 30 may take on any size, shape or design such as the exemplary housing for the instrument cluster 30 or the exemplary housing for the gauges 40. The housing 50 is illustrated generally in a sectional view in FIG. 4 as locating the backplate 60 a distance from the transparent plate 70. The backplate 60 may include various markings and visible indicia 44 for use in conjunction with pointers 42, to provide information, or provide status signals such as warning lights, turn signals and the like that are visible in visible light without the application of UV light. The housing generally includes walls 54 having inner surface 52 that engages the backplate 60. The housing 50 may be made in any size, shape or configuration. The housing 50 also generally includes a cavity behind the backplate 60 allowing for various electronic and other communication features (not illustrated).

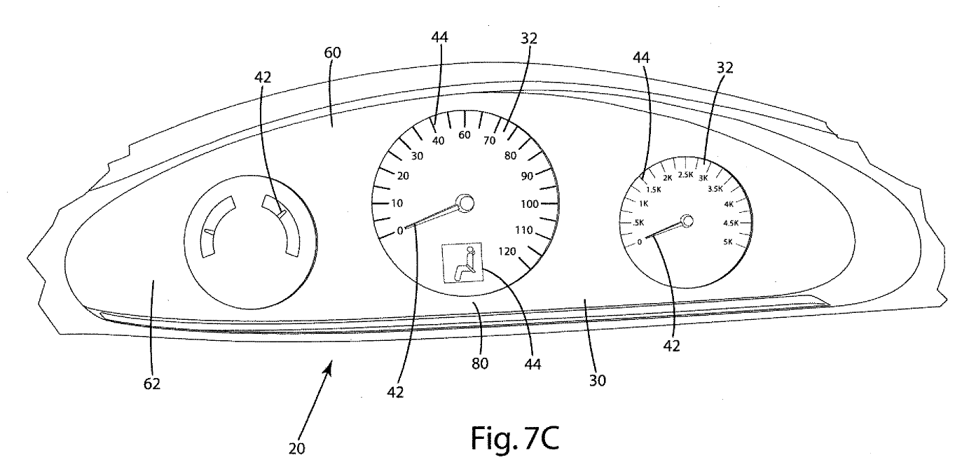

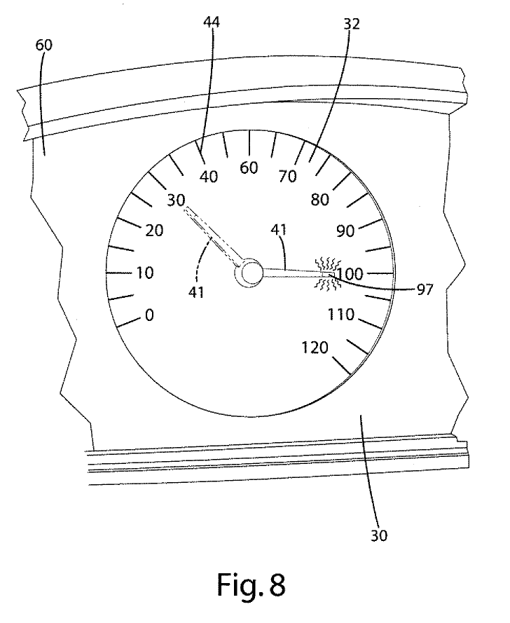

The backplate 60 has a front or display surface 62 facing the transparent plate 70. The front surface 62 may include the visible indicia and markings 44 as well as the above described UV indicia and markings 90. The UV indicia 90 may include markings such as numbers or marks between numbers, range markings, identification symbols and more. As used in this application, the indicia 90 may also include other status signals, warning signals and information signals. For example, status signals may refer to any vehicle status signals, including but not limited to turn signals, hazard light signals, headlights on signals, and hi-beam lights signals, seatbelt lights, glow plug lights, trailer connected lights, fuel level, and more. Information signals may be any signals that communicate information to the operator such as signaling when a particular item is outside a desired operational range. Warning signals may include but are not limited to engine temperature, oil pressure, check engine lights, and more. The backplate 60 may be made in any size, shape or configuration and may further include translucent portions that allow the status lights behind the backplate 60 to light up various status visible symbols and markings that form the visible indicia 44 to alert or communicate with the operator of the vehicle, as shown in FIG. 7C.

The transparent plate 70 is configured to allow the passage of visible light while blocking the passage of the UV light. The transparent plate 70 may be made in any size, shape or configuration to fit within the gauges 40 or instrument cluster 30. It is important that the transparent plate 70 block UV light to prevent any UV indicia or markings behind the transparent plate from illuminating in response to ambient UV light. For example, in certain conditions the sun may illuminate the backplate 60, which without the transparent plate would cause the UV indicia or markings 90 to illuminate visibly with light in the visible spectrum due to the UV light in sunlight. The transparent plate may be formed from polycarbonate or any other material that resists the transmission of UV light. In some embodiments glass panels that include a UV resistant coating may form the transparent panel also or other non-glass panels that include UV resistant coating or UV resistant materials embedded within the non-glass panels.

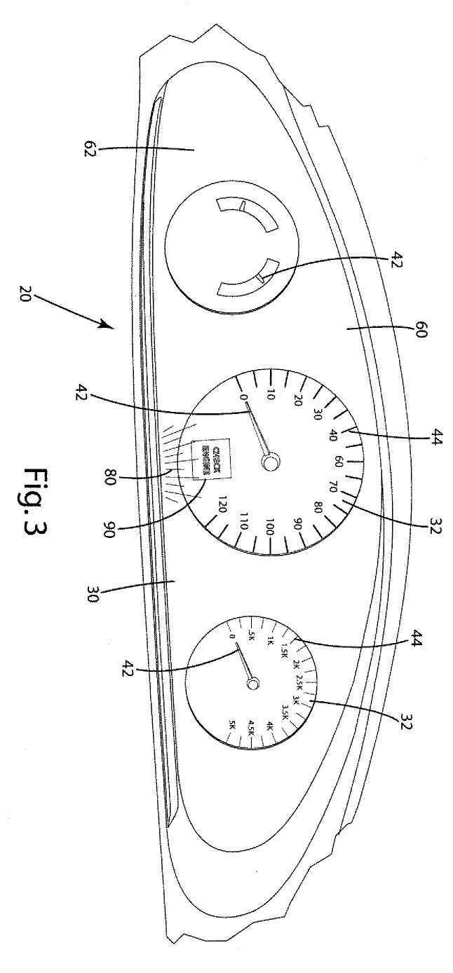

The UV light source 80 may be any UV light source capable of causing the UV indicia or markings 90 to illuminate or produce visible light viewable by the operator. The UV light source 80 provides ultraviolet light and in some instances, different UV light sources having different wavelengths of ultraviolet light may be used to allow for different UV indicia 90 to be individually illuminated in the same instrument cluster 30 or gauge 40. As illustrated in FIGS. 3, 7A and 7B, the same area of the instrument plate receives three different UV indicia or markings. For example, the first UV indicia or markings would be responsive to a UV wavelength while the second UV indicia or markings would be responsive to a UV wavelength, and the third to a third wavelength. This allows the gauges 40 or instrument cluster 30 to stack various UV markings or indicia 90 on one another thereby minimizing space requirements while still providing the desired status signals. As further illustrated in FIG. 7C, these UV indicia can even be stacked over other visible indicia without interference with such visible indicia.

The UV indicia 90 may be configured to provide different colors. For example, a green emitting phosphor is excited by UV at about 365 nm, red emitting phosphors at about 375 nm and/or 365 nm while blue emitting phosphor is excited at around 405 nm. The UV indicia 90 may be a single color and only responsive to a particular UV source 80. This allows by the blending of different phosphors the ability to produce any desired color. Variation in the shade of color may be made through using different amounts of selected colors of phosphor such as instead of 50% red phosphor and 50% green phosphor to give a standard yellow color to the UV indicia 90 the UV indicia may include 30% green phosphor and 70% red phosphor to shift the yellow indicia toward an orange color. Of course, instead of mixing different amounts of different color emitting phosphor in the UV indicia 90, applying different amounts of UV at a particular wavelength may obtain the same effect. More particularly, as one set of nanophosphor particles has a stronger illumination, the color changes. This allows for ease of manufacturing while allowing for almost any color and even allows for users to customize the colors emitted, for example, instead of a yellow color, the user could customize the color to a reddish purple.

The nanophosphorus particles forming the UV indicia 90 are not visible and the backplate 60 and any underlying visible indicia 44 may be seen through them. More specifically, the nanophosphorus particles have a size of approximately less than 400 nm and only become visible when UV light is applied. By only having the UV indicia be visible when UV light applies allows the UV indicia or markings to be applied over various backlit or front lit status signals. This allows, for example, a very large check engine light, much larger than is typical to illuminate and even flash to catch the driver's attention. The use of nanophosphorus particles applied to the backplate allows these various status signals without visibly detracting from the aesthetic effects of the instrument panel 20 under normal lighting conditions.

The use of different colors also allows the overlay of different signals or indicia in one area. For example, a first status signal may be back lit as in FIG. 7C and part of the visible indicia 80 and yet may be overlaid with three different UV indicia 90 as illustrated in FIGS. 3, 7A and 7B. If more than one of a particular indicia needs to be simultaneously displayed, they can flashingly rotate.

The nanophosphorus particles may be applied directly to the backplate or may be incorporated into a film that is applied then directly to the backplate. For example, the UV indicia 90 could be applied in a clear paint or other substrate to the backing plate. In other embodiments, the UV indicia 90 may be printed onto a film and then the film is applied to the backplate 90. In other embodiments, the UV indicia may be embedded into a film during the manufacturing process and then applied to the backplate. In each embodiment, the UV indicia is secured or coupled to the backplate either directly or indirectly without any substantial gap between the UV indicia 90 and the backplate 60. The UV indicia typically form less than 50% and preferably less than 30% by volume of the substrate in which they are incorporated. It is very important that the nanophosphor particles do not detrimentally effect the optical transmission of the substrate.

The UV indicia 90 may also be applied to or incorporated in other elements of the instrument panel 20. For example, a pointer 41 may include nanophosphor particles that illuminate in response to UV light. This allows for a lighted pointer without the need for a light pipe or actively lighting the pointer 41 with an incorporated LED. This also allows for the pointer 41 to change color, such as to signal the driver. For example, a temperature pointer for a vehicle may be blue when the engine is cold, fade into green when the engine is within the normal operating temperature range and fade into red as it approaches the upper range of the temperature range, with a full red pointer symbolizing a problem. Another example is where the engine rpm pointer fades to red 97 as the rpms approach the redline. These systems may even be customized by the user, such as the user setting a speed limit and the speed pointer changing to a red (or other desired color) when the set limit is exceeded.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A gauge for an instrument panel comprising:
a backplate including visible indicia;
at least one UV indicia applied to said backplate and wherein said UV indicia is visible only when UV light is applied and wherein said UV indicia is formed from nanophosphor particles.

2. The gauge of claim 1 wherein said UV indicia is substantially not visible when UV light is not applied.

3. The gauge of claim 1 further including a transparent pane and wherein said transparent pane is capable of blocking the passage of UV light while allowing the passage of visible light.

4. The gauge of claim 1 wherein said UV indicia is applied to a film and said film is coupled to said backplate.

5. The gauge of claim 1 wherein said visible indicia is applied to said backplate.

6. The gauge of claim 1 wherein said nanophosphor particles are embedded in a film and said film is applied to said backplate.

7. The gauge of claim 1 wherein said nanophosphor particles are approximately less than 400 nm in diameter.

8. The gauge of claim 7 wherein said nanophosphor particles in said UV indicia are spaced an average distance apart that is greater than the diameter of said particle.

9. The gauge of claim 1 wherein said nanophosphor particles form less than half of the volume of said UV indicia.

10. The gauge of claim 1 wherein said nanophosphor particles emit visible light in the range of wavelength for green when UV light is applied at about 365 nm.

11. The gauge of claim 1 wherein said nanophosphor particles emit visible light in the range of wavelength for blue when UV light is applied at about 405 nm.

12. The gauge of claim 1 wherein said nanophosphor particles emit visible light in the range of wavelength for red when UV light is applied at about 375 nm.

13. The gauge of claim 1 wherein said nanophosphor particles emit visible light at least two different colors when UV light is applied at least in two different wavelengths.

14. The gauge of claim 1 further including a housing securing said backplate and a transparent member spaced a distance from said backplate and a UV light source within said housing and between said transparent member and said backplate and wherein said transparent member is configured to substantially block the passage of UV light.

15. The gauge of claim 1 including a first UV light source at a first wavelength and a second UV light source at a second wavelength and wherein said first and second wavelengths are not equal and wherein said at least one UV indicia includes a first UV indicia and a second UV indicia and wherein said first UV indicia produces visible light when UV light is applied from said first UV light source and substantially does not produce visible light when UV light is applied from said second UV light source.

16. The gauge of claim 15 wherein said second UV indicia produces visible light in response to UV light being applied from said second UV light source.

17. The gauge of claim 1 wherein said UV indicia includes nanophosphor particles of approximately equal amounts in a single indicia of a first group of nanophosphor particles and a second group of nanophosphor particles and wherein said first and second nanophosphor particles respond to different input UV wavelengths and wherein said UV indicia is capable of illuminating in at least two colors.

18. The gauge of claim 17 wherein said first group of nanophosphor particles emit a first visible light wavelength range in response to a first UV light wavelength and said second group of nanophosphor particles emit a second visible light wavelength range.

19. The gauge of claim 17 wherein said UV indicia is capable of emitting a range of colors between said at least two colors that is a combination of said at least two colors.

20. The gauge of claim 19 wherein said range of colors is emitted in response to different amounts of UV upon said UV indicia at different wavelengths.

21. An instrument panel comprising:
a housing and a backplate disposed within said housing;
a transparent plate disposed within said housing and spaced apart from said backplate and wherein said transparent plate is configured to substantially block the passage of UV light while substantially allowing the passage of visible light;
an indicia on said backplate, said indicia being formed to not be visible under only visible light and to be visible when UV light is applied to said indicia; and
a UV light source disposed within said housing.

22. The instrument panel of claim 21 further including a film applied to said backplate and wherein said indicia is incorporated with part of said film.

23. The instrument panel of claim 22 wherein said indicia includes nanophosphor particles.

24. The instrument panel of claim 21 wherein said indicia includes two different types of nanophosphor particles, each of which provides visible light in response to different wavelengths of UV light.

25. The instrument panel of claim 21 wherein said indicia includes a first UV indicia and a second UV indicia and wherein said and wherein said first UV indicia emits a different color of visible light than said second UV indicia.

26. The instrument panel of claim 25 wherein said first UV indicia emits visible light in response to UV light in a first range and wherein said second UV indicia emits visible light in response to UV light in a second range and where said first and second ranges are approximately different.

27. The instrument panel of claim 21 wherein said UV indicia includes a first group of nanophosphor particles capable of emitting a first color, and a second group of nanophosphor particles capable of emitting a second color different from said first color and wherein said first and second colors may be combined to form a range of colors therebetween.

28. An instrument panel comprising:
a housing having walls;
a backplate disposed within said walls;
a transparent plate disposed within said walls and spaced apart from said backplate and wherein said transparent plate substantially blocks the passage of UV light while substantially transmitting the light within the visible spectrum;
an indicia including nanophosphorus particles applied to a surface of said backplate, said surface facing said transparent plate, and wherein said indicia is not spaced a distance from said backplate;
a UV light source and wherein said indicia including said nanophosphor particles is only visible when UV light is applied from said UV light source.

29. An instrument panel comprising:
a housing;
a backplate disposed within said housing;
a plurality of indicia on said backplate and a pointer arranged to point to said indicia based upon an input and wherein said pointer includes a first group of nanophosphor particles and a second group of nanophosphor particles and wherein as said pointer moves across said indicia the intensity of emitted visible light from said first group of nanophosphors decreases while said second group of nanophosphor particles increases.

30. The instrument panel of claim 29 wherein said pointer changes color as it moves across said indicia.

31. The instrument panel of claim 29 further including a source of UV light at at least two different wavelengths.

32. The instrument panel of claim 31 wherein said UV light source provides a first wavelength of UV light and a second wavelength of UV light and as said pointer sweeps across said indicia, the intensity of said first UV wavelength decreases and the intensity of said second wavelength increases.

33. The instrument panel of claim 29 wherein said pointer is one of substantially transparent or substantially translucent.
